(19) United States
(12) Patent Application Publication
(10) Pub. No.: US 2026/0079229 A1
(43) Pub. Date: Mar. 19, 2026

(54) MULTILATERATION FOR GEOLOCATION OF TARGETS

(71) Applicant: CHAOS INDUSTRIES, INC., Hermosa Beach, CA (US)

(72) Inventors: Harry Bourne MARR, JR., Manhattan Beach, CA (US); Brian HAY, Torrance, CA (US); Justin HODIAK, El Cajon, CA (US); Mark Jeffrey ROSKER, Falls Church, VA (US); Ryan RETTING, Torrance, CA (US); Son DOAN, Westminister, CA (US); William DOWER, Hermosa Beach, CA (US)

(21) Appl. No.: 18/886,895

(22) Filed: Sep. 16, 2024

(51) Int. Cl. G01S 5/06

(52) U.S. Cl. CPC G01S 5/06; G01S 13/003; G01S 2013/466

(57) ABSTRACT

Disclosed are systems, methods, and computer programs for determining a range to a target. A system can include a first receiver configured for receiving a first signal from the target and a second receiver configured for receiving a second signal from the target, the second receiver time-synchronized with the first receiver. A programmable processor can determine a range to the target based on arrival times of the first signal at the first receiver and the second signal at the second receiver.

### DESCRIPTION OF THE RELATED ART

Target location and tracking can be performed to facilitate military, scientific, or other applications. Expensive and sophisticated radar systems can be utilized to determine distances to targets such as aircraft, weather phenomena, etc. With very advanced radar systems there can be no need for multiple interconnected stations and instead a radar system can be a single centralized station. Also, the size and sophistication of large radar systems can permit them to operate at high frequencies despite the reduction in signal that is often associated with high-frequency operations.

### SUMMARY

Disclosed are systems, methods, and computer programs for determining a range to a target. In one aspect, a system can include a first receiver configured for receiving a first signal from the target and a second receiver configured for receiving a second signal from the target, the second receiver time-synchronized with the first receiver. A programmable processor can determine a range to the target based on arrival times of the first signal at the first receiver and the second signal at the second receiver.

In some variations, the first receiver and the second receiver can be time synchronized directly with each other or with an external clock. The first receiver and the second receiver can be time synchronized to within 10 nanoseconds or to within 10 picoseconds.

In some variations, a transmitter can be configured to emit a third signal that causes generation of the first signal and the second signal. The transmitter can be configured to generate the third signal omni-directionally or can be configured to generate the third signal to have a transmitter beamform. The processor can be further configured to limit the range of the target to be based on a location within the transmitter beamform.

In some variations, the system can include a second transmitter configured to emit a fourth signal that causes generation of the first signal and the second signal in response to transmission of the fourth signal, the processor further configured to toggle between the first transmitter and the second transmitter to generate the first signal and the second signal.

In some variations, the system can include a second transmitter configured to emit a fourth signal that causes generation of the first signal and the second signal in response to transmission of the fourth signal, wherein the first transmitter and the second transmitter are offset in frequency to provide a first frequency bandwidth and a second frequency bandwidth that provides a total frequency bandwidth larger than the first frequency bandwidth and the second frequency bandwidth, and wherein the first receiver or the second receiver is configured to receive the total frequency bandwidth.

In some variations, the third signal and the fourth signal can be generated phase coherently or pulse coherently.

In some variations, the first receiver or the second receiver can have a linear array of antenna elements. The first receiver can have a first linear array in a vertical direction and the second receiver can have a second linear array in a vertical direction. The first receiver or the second receiver can be further configured to transmit outgoing signals to another system.

In some variations, the first receiver can have a first location and the second receiver can have a second location, and the range can have a range accuracy based on the time synchronization between the first receiver and the second receiver, and an angular accuracy based on a spatial diversity of the first receiver and the second receiver, and antenna beamforms of the first receiver and the second receiver, the processor can be further configured to: determine a range accuracy based on the range, range accuracy, and angular accuracy, where the angular accuracy is determined based on a volume formed by a union of overlapping detection volumes of the first receiver and the second receiver.

In some variations, the processor can be further configured to: determine a time-synchronization level of the system that provides the range accuracy by a multilateration method; determine the time-synchronization level of the system for an interferometric range accuracy by an interferometric method utilizing the first signal and the second signal; and switch to the multilateration method or the interferometric method based on the time-synchronization level.

In some variations, the first receiver and the second receiver can be configured to receive the first signal and the second signal having a frequency of less than 6 MHz, less than 200 MHz, or between 2 and 20 MHz. The system can be configured to determine the range to within 10 m utilizing at least two receivers configured to receive a signal of less than 20 MHz.

In some variations, the system can include a plurality of transmitters to generate signals that have a distinguishing characteristic that allows them to be distinguished at a receiver, the processor further configured to determine the range further based on the distinguishing characteristic. The distinguishing characteristic can be a difference in one or more of a phase, a frequency, an amplitude, a polarization, time of transmission, or spatial location of transmission.

In some variations, the system can determine a location of the target from the first signal and the second signal and determining doppler frequencies of the first signal and the second signal. The system can generate a five-dimensional map comprising a three-dimensional location of the target, as a function of time, and as a function of the doppler frequencies.

In some variations, the target can be moving and can be an aircraft or a maritime vessel.

In some variations, the target can be stationary and can be a geological feature.

In some variations, the first signal can be tuned to an absorption line of the target and the second signal is not tuned to an absorption line of the target, the processor further configured to determine a size of the target based on an attenuation of the first signal after passing through the target. The first signal and the second signal are RF signals or are laser beams.

In an interrelated aspect, a system for locating a target can include a transmitter configured for transmitting an outgoing signal to the target; a receiver configured for receiving an incoming signal from the target, the receiver time-synchronized with the transmitter; and a programmable processor configured to determine a range to the target based on an arrival time of the incoming signal at the receiver.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A is a diagram illustrating a simplified system utilizing two receivers in accordance with certain aspects of the present disclosure,

FIG. 1B is a diagram illustrating a simplified node, for example a transmitter or receiver in accordance with certain aspects of the present disclosure, and

FIG. 2 is a diagram illustrating a simplified system utilizing two receivers and a transmitter in accordance with certain aspects of the present disclosure.

FIG. 3 is a diagram illustrating a simplified system utilizing a directional antenna in accordance with certain aspects of the present disclosure.

FIG. 4 is a diagram illustrating a simplified system utilizing a transmitter having a transmitter beamform in accordance with certain aspects of the present disclosure.

FIG. 5 is a diagram illustrating determination of cross-range and down-range accuracy with a single receiver in accordance with certain aspects of the present disclosure.

FIG. 6 is a diagram illustrating improvement of cross-range and down-range accuracy with two receivers in accordance with certain aspects of the present disclosure.

FIG. 7 depicts plots illustrating how an increase in signal-to-noise can maintain accuracy even as range increases in accordance with certain aspects of the present disclosure.

FIG. 8 depicts an example of a five-dimensional representation of received signals during target tracking in accordance with certain aspects of the present disclosure.

FIG. 9 depicts an embodiment that can be utilized for determining the size of a gaseous target in accordance with certain aspects of the present disclosure.

FIG. 10 is a diagram illustrating a simplified system utilizing one receiver and one transmitter in accordance with certain aspects of the present disclosure.

### DETAILED DESCRIPTION

The present disclosure relates to, for example, utilizing systems, methods, and computer software for utilizing coherent distributed networks of transmitters and/or receivers for applications such as target detection/rangefinding, environmental feature assessments, and signals intelligence.

Many embodiments of the present disclosure utilize nodes (e.g., a transmitter, receiver, or transceiver) that are highly time-synchronized with each other or with another system to allow precise determination of when signals are sent/received. Such synchronization results in what the present disclosure refers to as a coherent system. While a high level of synchronization is beneficial for more precise applications, the exact amount of synchronization can vary with the embodiment. The present disclosure provides examples of degrees of synchronization, but no particular degree is considered essential in any given embodiment.

Where the present disclosure refers to “receivers” or “transmitters,” such is understood to mean devices that include at least those elements but may include other capabilities. For example, a “receiver” may be embodied as a device with receiving capability but no transmitting capability, but other embodiments of “receivers” may also include transmissive capabilities, whether transmission is utilized or not. The same is true for the disclosed transmitters. The present disclosure also refers to such elements as “nodes” and the present disclosure contemplates any number of such, including a large number of interconnected nodes that can establish a coherent and wide-coverage network. While the present disclosure provides examples utilizing a low number of nodes, in various embodiments this can be extended to two, three, four, or more nodes.

The disclosed transmitters and receivers can be configured for various modes of operation, depending on the embodiment. For example, they can be utilized with RF signals (e.g., in the kHz or MHz range), light (e.g., laser) signals (e.g., in the GHz range), etc.

As used here herein, the term “signals” can refer to actual electromagnetic signals (e.g., RF, laser, etc.) but can also refer to their representation of same in a device (e.g., a digitized signal in an electronic circuit or as data in computer memory).

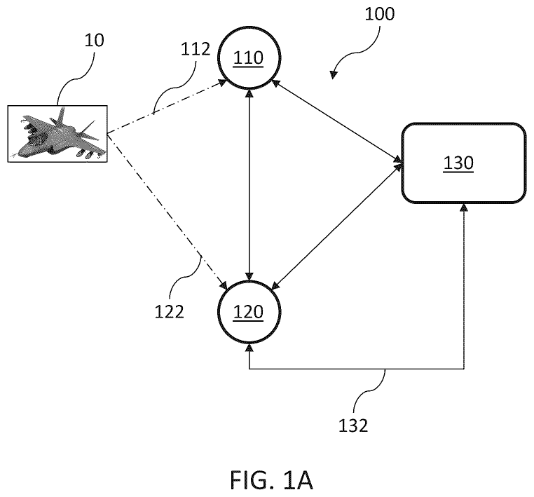

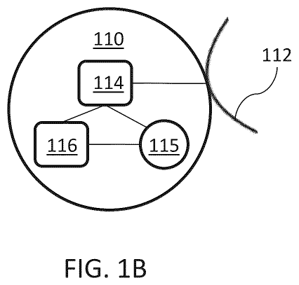

FIG. 1A is a diagram illustrating a simplified system utilizing two receivers. The system shown in FIG. 1A can be utilized, for example, for rangefinding. A first receiver 110 can be configured for receiving a first signal 112 from target 10. A second receiver 120 configured for receiving a second signal 122 from target 10. To facilitate accurate rangefinding and location determination as described herein, second receiver 120 can be time-synchronized with first receiver 110. The times of receipt of signals can be relayed between receivers but also to a computer system 130 to analyze the data about the received signals. Computer system 130 can include a programmable processor configured to determine, for example, a range to the target based on arrival times of the first signal at the first receiver and the second signal at the second receiver. While rangefinding is one possible application of such a system, other applications can include, for example, target locating, signals intelligence, etc., as disclosed herein. Other applications with the disclosed technology are also possible and so the disclosure should not be considered as limiting to only the described example use cases.

FIG. 1B is a diagram illustrating a simplified node, for example a transmitter or receiver. The depicted receiver 110 can include, for example, antenna 117 to provide either directed or omnidirectional receiving capabilities for capturing incoming signals. Signal processing electronics 114 can be included to convert the signals received at antenna 117 to electrical signals. Clock 115 can be included to facilitate the time synchronization disclosed herein. Power supply 116 can be provided to provide electrical power to the signal processing electronics 114, clock 115, or other subcomponents. While this example is for a receiver, the structure can similarly be applied as a transmitter, for example including the antenna 117 for transmission of signals generated at signal processing electronics 114 and accurate timekeeping by clock 116.

To facilitate precise rangefinding, accurate target location, or other operations, first receiver 110 and second receiver 120 can be time synchronized. In some embodiments, they can be time synchronized directly with each other (e.g., each having onboard clocks that have been synchronized). In some embodiments, first receiver 110 and second receiver 120 can be time synchronized with an external clock (e.g., a clock at a remote server, a transmitter, a receiver, or other hardware containing a digital clock). In many embodiments, a high degree of time synchronization can be required to achieve a desired accuracy of the determined quantities of interest (e.g., range, location, etc.). In some embodiments, first receiver 110 and second receiver 120 can be time synchronized to within 10 nanoseconds, to within 10 picoseconds, or even more precisely. A time synchronization being within 10 nanoseconds can for example, limit this source of error to only approximately 3.3 m.

While there can be several different types of time transfer protocols categorized, two can include: one-way time transfer or two-way time transfer. Both one-way and two-way protocols can be implemented wirelessly or wired. Terrestrial wireless links include Wifi, millimeter-wave, radio frequency (RF) wireless, optical free-space optical protocols, etc. Space-based wireless protocols can include satellite two-way time transfer as well as one-way time transfer via global positioning satellite system (GPS) hardware which is RF based, and space-based laser protocols, etc. Wired protocols can include precision time protocol (PTP) methods implemented through network based and ethernet based wired networking protocols, both through copper wires and optical fiber, for example. Two-way time transfer can generally be broken down further into peer-to-peer protocols, where either two nodes are time synchronizing with each other, or where multiple nodes are still doing peer-to-peer with each other, but in a networked configuration where two nodes synchronize, A with B, and then either A with C or B with C sequentially, etc. The present disclosure provides additional technical improvements to, for example, two-way time transfer protocols that accomplish one-to-many (e.g., broadcast) two-way time transfer. This one-to-many time transfer can also be networked such that A broadcasts to B, C, D, and B, C, D complete the two-way time transfer protocol with A, and then D broadcasts to E, F, G, and completes the two-way time transfer protocol with D such that now nodes A, B, C, D, E, F, and G are all time synchronized. One-way time transfer protocols, such as GPS have been shown to achieve nanosecond level of precision, for example 5 ns to 10 ns. This nanosecond-level of precision represents a fundamental limit for space-to-earth one way time transfer protocols such as GPS, such that these space-based one-way time transfer protocols are not sufficient for better than nanosecond resolution. Better than nanosecond resolution is of course desired for distributed, sparse and uniform phased array sensing operation. This is because time transfer relies on knowing two variables: both the time offset of two different nodes as well as the path delay between those two nodes. One-way time transfer represents a single equation (time difference equals time clock offset plus path delay) with two variables (clock offset and path delay) and so to solve this with only one-way time transfer, such as GPS, the path delay variable must be estimated. In GPS this is done by estimating the altitude of the GPS satellites above the receive node on earth and then estimating how long the speed of light takes to traverse this path. The path delay of light is known precisely only in a vacuum because in atmosphere the light refracts different amounts depending on pressure, temperature, humidity, air density and many other factors. Because of scintillation and refraction of light the exact path length is not known exactly. This path variability creates a 5-20 ns of variability in the path delay variable, creating a 5-20 ns limit on how accurately one way time transfer can be done with GPS.

To achieve picosecond level time transfer, protocols a wide bandwidth one-way wireless time transfer protocol can be used, such as free-space optical or high-frequency RF hardware where the nodes are close together for example up to a limit of several dozen kilometers. For further distances, two-way time transfer protocols can be used. High bandwidth wireless RF can include the unlicensed band hardware at 2.4 GHz, 5.8 GHz and 60 GHz including an RF modem, a dish antenna, and frequency generation hardware. Silicon phased arrays and other phased array hardware can be used to implement the RF wireless time transfer protocols. Whether one-way or two-way, phased arrays have the advantage of being able to move the beam very quickly for broadcast-type protocols for the one-to-many time transfer protocols described previously. Two-way time transfer protocols such as white rabbit can be implemented in hardware and are independent of the medium on which the signal passes. A field programmable gate array (FPGA) with ethernet drivers and the time transfer protocol logic programmed into the device can also be implemented in an embodiment. For example, mmWave wireless RF, free-space optical, and laser-based signals can be down converted into a wired optical fiber signal. Or a wired optical fiber, some of which can be up to hundreds of kilometers long, can be installed such that the interface to the white rabbit control hardware can be always the same and can be independent of the medium over which the signal travels. Optical fiber can be beneficial for the interface to white rabbit and other hardware and FPGA-based programmed time transfer logic because optical fiber is very wide frequency bandwidth compared to RF. Where RF is the only option, the wireless RF protocols can be directly converted to time transfer protocols such as a system on a chip device where wideband RF digitizers are directly embedded into an FPGA device creating an RF system on a chip (RFSoC). Each of these methods has different performance. The fewer switches and conversion of medium a signal has to go through, the better the time accuracy. For example, if no routing of the signal has to occur (direct from node A to B) rather than routing a signal (time sync A to B and then B to C) the better the synchronization. Also, the higher frequency the medium of exchange the more accurate the time synchronization is, so optical and optical fiber is more accurate than RF because optics are up in the 100s of THz frequency range and time resolution is proportional to frequency bandwidth. Accordingly, some embodiments can achieve excellent results with a direct optical fiber peer-to-peer link. This can involve the highest frequency medium (optical), the fewest conversions of medium (all wired), and the fewest switches (direct peer-to-peer). In this configuration, time synchronization in the hundreds of femtoseconds has been achieved. RF wireless has achieved into the tens of picoseconds regime at very short ranges. Another factor in time protocols is the drift rate of the clock and how long the application requires the nodes to be synchronized. For example, in radar, a series of pulses known as a “frame” or a “coherent processing interval” can be sent that involves hundreds or thousands of radar pulses integrated coherently. A CPI or frame time often consumes 100s of microseconds, milliseconds, seconds or even 10s of seconds in time, with some static underground mapping applications requiring hours of coherent time. With a given coherent time requirement, which is a function of frequency (typically 10% or 1% of the time it takes light to travel that wavelength, such as at VHF frequency the requirement would be 100's of picoseconds, whereas at L-band 10's of picoseconds, and at X-band single digit picoseconds), the on-board clock on that node must be stable for that amount of time to within that requirement. For example, with a 1 second long radar CPI at L-band, the clock must not drift more than 10-100 picoseconds over a 1 second period. In some embodiments, a quantum and/or low phase noise atomic clock can be used on the node(s). However, regardless of clock type, the disclosed systems and methods can account for the interval over which the clock has unacceptable drift, and set the time synchronization recalibration interval to that level. For example, if a standard quartz oscillator clock is on board each node, which drifts more than 100 ps every 100 milliseconds, in one implementation we can implement time synchronization logic as often as every few pulses or every pulse such that the nodes are re-synchronized more often than 100 milliseconds. Any or all of these factors (time transfer protocol, medium of time transfer, number of nodes, precision requirement, time calibration interval, on board clock draft accuracy) can be taken into account in the disclosed systems and methods to tune the system to meet desired requirements.

In a multi-node system, where there can be multiple receivers and, in some embodiments, multiple transmitters where multilateration can be implemented to geolocate targets, the present disclosure provides very high-performing radar system as well as many other sensor systems such as signals intelligence, communication systems, and others, much less expensively than a monolithic and monostatic systems such as modern surface-to-air missile radar system. This is because cost of radar components is generally proportional to the applied frequency. Historically, radar and other sensor systems go higher in frequency to achieve better frequency bandwidth as well as better spatial resolution. The spatial resolution of a monolithic, single node phased array can be dependent on the width of the monolithic phased array length and width extent, such as 1 to 2 meters, usually limited by what can fit on the back of a vehicle and the frequency. Historically, with the size of the phased array fixed, such as the size of the back of the vehicle, the only way to achieve better spatial resolution is to go higher in frequency such as X-band or Ku-band or even millimeter-wave frequencies such as Ka-band and W-band. Higher frequencies have the distinct features that while the attenuation and free space path loss decrease with the square of the frequency increase, the power out of power amplifiers also decreases with the square of the frequency and the efficiency of power amps also decreases with the square of the frequency. The results are that, to achieve a given range to a target at higher frequencies, the system can require significant increases in many dimensions (size of the array, number of elements, number of power amps, etc.).

However, the approach described herein can achieve very precise spatial resolution and very wide bandwidths all using inexpensive very long range low-frequency components to achieve orders of magnitude better cost efficiency and performance for a given range to target and given spatial resolution. This can be in part because spatial resolution is achieved not necessarily by going higher in frequency to achieve smaller beamwidths, but by time synchronizing multiple receive nodes to triangulate and multi-laterate the target using multilateration and interferometry methods where are dependent primarily on the distance the nodes are a part rather than the frequency and resulting beamwidth. For example, instead of the elements being 1-2 meters apart (e.g., such as a phased array in the back of a vehicle), the nodes implemented with the present disclosure can be hundreds of meters or even multiple kilometers apart. In some embodiments, nodes can be 20 km apart, but can also be spaced up to 50 km, for example using wireless point to point time transfer protocols where Wifi S-band hardware achieves these distances to interconnect nodes wirelessly. In some embodiments, line-of-sight from node to node may not be required, such that the nodes can be anywhere on Earth using. For example, internet-based timing protocols such that each node just needs to be connected to a network, or space-based timing protocols can be implemented. In addition to the range accuracy being a key element for each node, the multi-static angle to the target required to achieve a given spatial resolution accuracy can be somewhat dependent on the bandwidth. In some embodiments, a 90 degree angle in two dimensions can be implemented, such that for an airborne target, one receiver can be directly in front of the target, one receiver can be directly 90 degrees to the side of the target, and one receiver can be directly beneath the target. This configuration, among others, can achieve spatial resolution that is not achievable at any frequency with a monolithic, monostatic system. While the multistatic system still outperforms the monostatic system in spatial resolution for any angle, as the multistatic angle to the target diverges from 90 degrees, such as at 10 or 20 degrees, which can be the case for airborne target identification radar due to logistics involved, the multistatic system can still be more accurate for tighter multistatic angles as the range accuracy number increases, which is dependent on frequency bandwidth.

Very wideband receiver hardware can be utilized in various embodiments, such as 100:1 bandwidth antennas (100 MHz to 10 GHz). Other embodiments can utilize direct wideband digitizers such as RF systems on a chip (RFSoC) with wideband highspeed direct analog-to-digital converters, which can be used to achieve wide receive bandwidths even at low center frequencies. In some embodiments, 50 MHz wide bandwidths can be utilized and that are sufficient to achieve better than 10 meter range accuracy even at low VHF frequencies. Some systems can be limited in bandwidth by the transmit power amplifier, due to the Bode-Fano limit, which limits transmit bandwidth for a given power amp efficiency and thus output power. Wideband GaN and LDMOS power amplifier technology is able to achieve ever wider transmit bandwidths even for a preferred transmitter. In our multistatic system, transmitters can be programmed with different frequency bandwidths, such that each individual transmitter only needs to achieve narrow bandwidths. For example, there can be five transmitters each with 10 MHz bandwidth, but have contiguous offset frequencies to output 50 MHz of bandwidth in aggregate. Such a configuration can easily be used by a multistatic wideband receiver to achieve very good range performance at each individual receive node such that the multistatic system is able to achieve very good geolocation target accuracy even at narrow multistatic angles such as 10 or 20 degrees. Thus, very accurate target tracking and target acquisition geolocation of objects can be achieved at low frequencies for very low cost, in some cases several orders of magnitude less than monostatic, monolithic systems such as expensive state of the art surface to air defense radars. Some implementations can include radar systems built with inexpensive VHF or UHF can thereby be configured to achieve better than 1 ps of time synchronization and outperform range and target accuracies of prior radar systems. In implementing the disclosed time synchronization, in some embodiments the system can have synchronized digital clocks (e.g., clocks in onboard processors on the nodes). In other embodiments, signals transmission/receipt at the nodes can be stored and time-stamped and different data packets with time-stamped data can be synchronized at a node or other processor as part of the analysis.

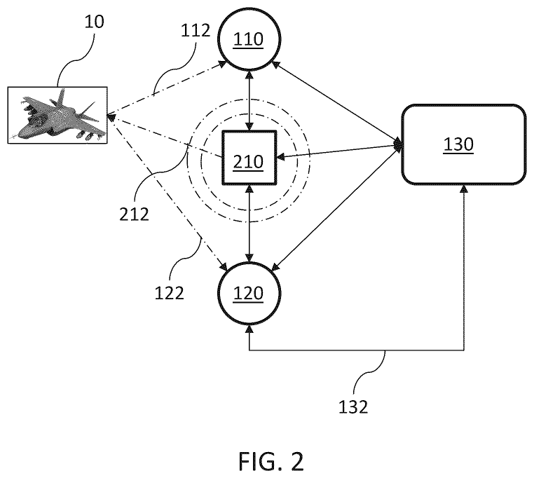

FIG. 2 is a diagram illustrating a simplified system utilizing two receivers and a transmitter. This embodiment is similar to FIG. 1A, but also includes transmitter 210 configured to emit a third signal 212 that causes generation of first signal 112 and second signal 122 (e.g., by virtue of reflection off target 10). In some embodiments, transmitter 210 can be configured to generate third signal 212 omni-directionally. This is depicted by the circular emissions shown in FIG. 2.

In various embodiments, the transmitter can be a VHF (e.g., less than 200 MHz) radar transmitter. Such comparatively low-frequency transmitters (and receivers) can, in some embodiments, be smaller and cheaper than high-frequency early-warning radar systems that might operate in the GHz range. In some embodiments, the VHF nodes can approximate 10 km apart, and contain three or more nodes, which can allow target tracking out to 500 nautical miles. In some embodiments, VHF modes (e.g., 2-20 MHz) can be used for over-the-horizon applications to allow target tracking over thousands of nautical miles.

In the example of FIG. 2, the range from receiver 110 can be determined by time-of-flight of first signal 112 reflecting or being emitted from the aircraft to target 10. The range from receiver 120 can be determined by time-of-flight of the second signal 122 being reflected from or emitted from target 10. Thus, the following system of equations that can be utilized to determine the unknown range to the transmitter 210:

$$c Δ {T}_{1} = {R}_{T} + {R}_{110} , \qquad ( Eq . 1 )$$

$$c Δ {T}_{2} = {R}_{T} + {R}_{120} , \qquad ( Eq . 2 )$$

where R_{T} is the range from transmitter 210 to target 10, c is the speed of light, ΔT₁ is the total time delay of a signal between transmitter 110, target 10, and receiver 110, and ΔT₂ is the total time delay of a signal between transmitter 110, target 10, and receiver 120. Equation 2 also hold for the case that the target 10 is emitting a signal, such as a control, data, radar, communications or other type of transmission—in such cases, R_{T}=0. The transmitter 210 can even be a third party source not controlled by the radar system, such as a TV tower, FM or AM radio tower, a cell phone signal tower, etc. For example, receiver 110 and receiver 120 can receive a direct line of site from the third-party transmission and thus it can be determined when the transmission occurred. Such determinations can be facilitated by having the multiple receivers to be time synchronized very closely so the time error doesn't affect the range calculation (e.g. speed of light times the time error will dictate the range error).

There can also be embodiments with multiple transmitters being utilized to emit signals and such configurations can have several advantages. The transmitters can blink/toggle on and off such that one transmitter emits a pulse (that generates signals reaching the target) and then another transmitter emits a similar pulse in an interleaved fashion. This can prevent an enemy from locating the transmitter based on the transmitted pulse because the source of transmission is changing rapidly. In some embodiments, multiple transmitters transmitting phase coherently, or coherently at the pulse level so at least their pulses overlap, can put more energy on the target than a single transmitter, increasing the range of effectiveness of the system. In some embodiments, the transmitters can be offset in frequency such that one transmitter transmits, for example, a first frequency bandwidth (e.g., at 200 MHz to 220 MHz), and the second transmitter transmits a second frequency bandwidth (e.g., at 220 MHz to 240 MHz), with the receivers being wideband receivers configured to receive the total frequency bandwidth (e.g., from 200 to 240 MHz). This can enable a much wider frequency system than would be achievable with a single transmitter, where the wider frequency bandwidth system achieves better downrange resolution. This is because transmitters are often the bottleneck in the frequency bandwidth of the system due to the Bode-Fano limit. This is a physical limit which says that power output or efficiency or both drop off with any frequency bandwidth wider than 8-10% of the carrier frequency of the system. In the 200-240 MHz example, 40 MHz is the frequency bandwidth and carrier frequency starts at 200 MHz, so this is a 20% bandwidth system that can be built with very high power and very efficient power amplifiers, thus multiple transmitters are a way around the Bode-Fano limit.

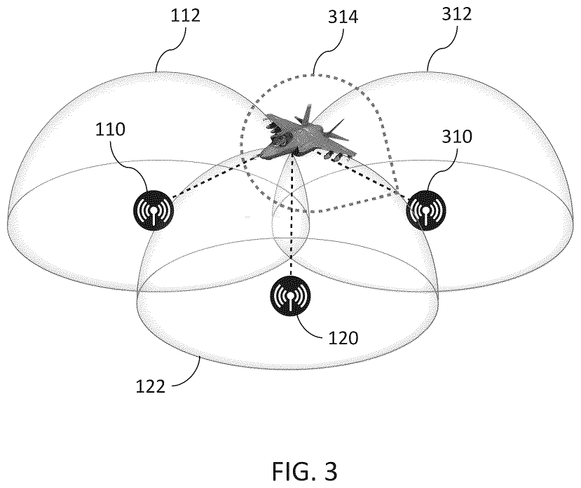

FIG. 3 is a diagram illustrating a simplified system utilizing a directional antenna. To improve the multilateration techniques described herein, some embodiments can utilize receivers that are configured to have directional antennas that effectively limit the possible ranges/locations of the target. In the example of FIG. 3, third receiver 310 has been included that is configured to receive signals in receiver beamform 314. When the receivers receive signals from target 10, applying multilateration can create a nexus of possible target locations. An example of this is depicted in FIG. 3 where it can be seen that for the simplified example of three overlapping spheres (having ranges to target 10 indicated by the size of the spheres of first signal 112, second signal 122, and third signal 312) that there are many possible locations of target 10. This uncertainty can be reduced by knowing receiver beamform 314 that can be received by third receiver 310. Receiver beamform 314 can be within a lobe, cone, or other shape such that there is effectively no reception in at least some directions. While radiation pattern 314 can vary, in some examples the receiver beamform can cover less than 2π, π, 0.5 π, etc. steradians.

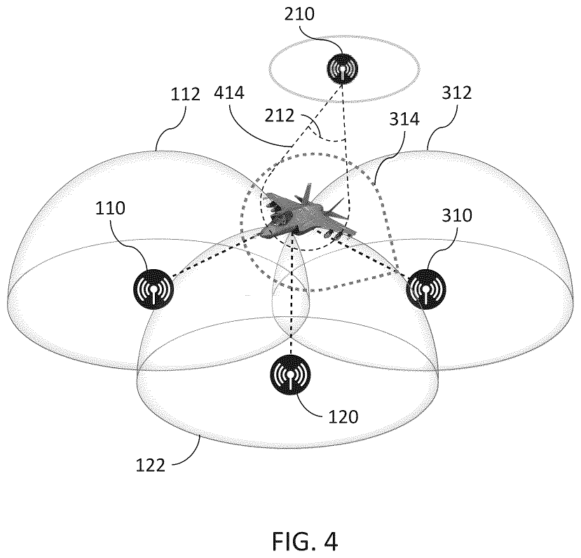

FIG. 4 is a diagram illustrating a simplified system utilizing a transmitter having a transmitter beamform. In some embodiments, to further improve determination of target location, range, etc., transmitter 210 can be configured to generate third signal 212 to have transmitter beamform 414. In this way, for example when determining a range to target 10, the processing system can be configured to limit the range of target 10 to be based on a location within transmitter beamform 414. The transmitter beamform can be similar to the previously-described radiation pattern in that it can cover varying solid angles with its directional transmissions, for example covering less than 2π, π, 0.5 π, etc. steradians.

While the disclosed receivers can have onboard processing that can allow them to determine the desired quantities themselves, in some embodiments, first receiver 110 or second receiver 120 can be further configured to transmit an outgoing signal to another system. Examples of such systems can include other receivers, transmitters, or processing systems. Such distributed networks of interconnected transmitters, receivers, and/or processors can facilitate flexible, mobile, and inexpensive target detection and rangefinding systems.

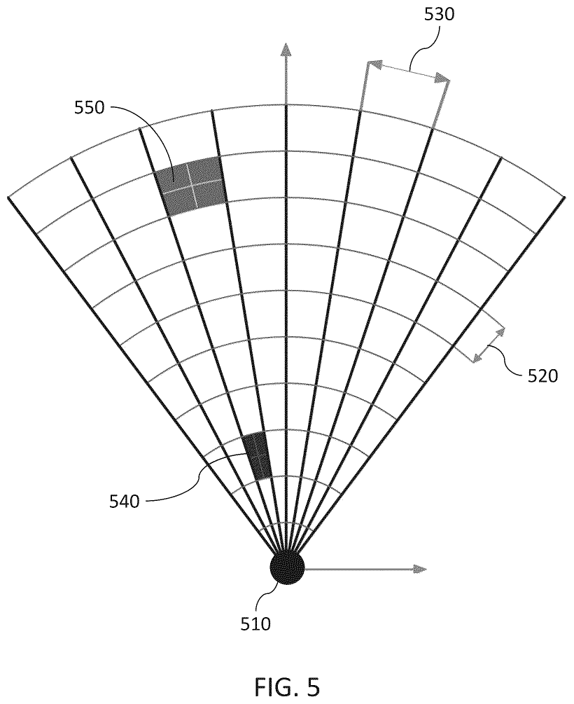

FIG. 5 is a diagram illustrating determination of cross-range and down-range accuracy with a single receiver. Before discussing the advantageous effects of having multiple receivers, a description of two metrics relevant to the target location will be presented. FIG. 5 shows a diagram of a single receiver 510 and how range accuracy depends on range resolution and target location. Two resolutions are depicted-down-range resolution 520 (range generally in a radial direction from receiver 510), and cross range resolution 530 (range generally in a lateral direction to receiver 510). Down-range resolution 520 is generally independent of distance from receiver 510 and is based primarily on uncertainty in knowing the precise location of receiver 510, though an additional uncertainty can be introduced based on the degree of time-synchronization with other transmitters/receivers. In some embodiments, down-range resolution 520 can be primarily based on the frequency bandwidth of the signal, such that the larger the frequency bandwidth, the larger the downrange resolution of the signal. Cross-range accuracy can be based on cross-range resolution (e.g., an angular resolution) and thus have a geometric dependence on distance as depicted by the two shaded location windows shown in FIG. 5. First window 540 (relatively close to receiver 510) can have a fairly high cross-range accuracy, whereas second window 550 (that is further from receiver 510, but with the same cross-range (angular) resolution) can have a lower cross-range accuracy. As the cross range resolution of each node improves, this improves the overall cross range resolution of the system of nodes. An individual node can improve its own cross range resolution performance by using phased array beamforming techniques such as monopulse, null steering, using a larger array to get tighter beam angles, and using higher frequency to get tighter beam angles.

In some embodiments, a system can include receivers with linear arrays of antenna elements. For example, in some embodiments, a first receiver can have a first linear array in a vertical direction and a second receiver with a second linear array in a horizontal direction. This is because a linear array gives the maximum possible resolution for that number of antenna elements in the direction of the array, for example a vertical linear array gives improved (e.g., the maximum for that number of elements) resolution in elevation, and a horizontal linear array can give the maximum resolution in azimuth.

Interferometry can be implemented as another method to increase cross range resolution between different receivers. Instead of using the triangulation method in FIG. 2, phase interferometry can be used between the two or more multistatic receivers to get a precise location in cross range of the target. Phase interferometry requires the two receivers to be time synchronized down to a fraction of the wavelength, which can be a tighter time requirement than the triangulation method, but can give higher accuracy. In some embodiments, the system can through software determine what time synchronization level has currently been achieved given the clock, timing, and environmental conditions. The system can then determine which geolocation method to use: the disclosed multilateration method or utilizing interferometry (which can include phase difference of arrival methods, time difference of arrival, frequency difference of arrival, amplitude difference of arrival methods) based on the time synchronization currently achievable in the system with such two available methods.

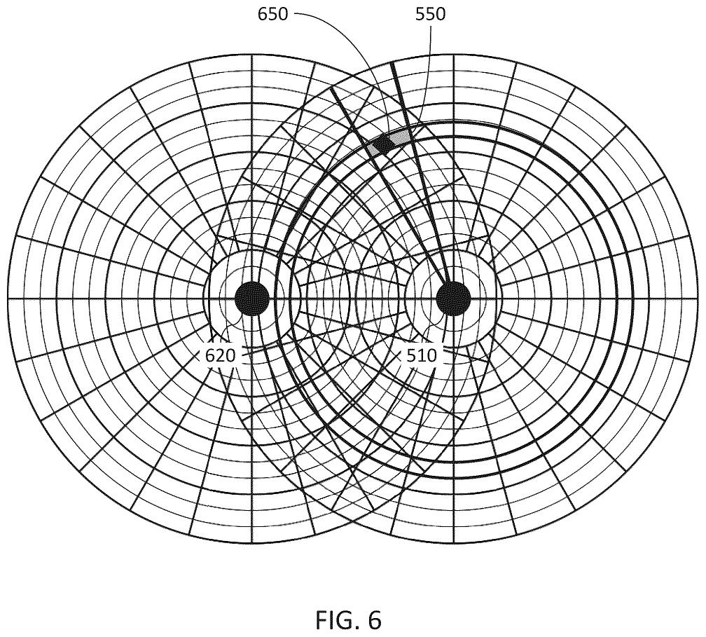

FIG. 6 is a diagram illustrating improvement of cross-range and down-range accuracy with two receivers. In various embodiments, the addition of transmitters and/or receivers can improve the accuracy of the system by narrowing the possible locations of the target. Expanding on the example of FIG. 5, receiver 610 is added with its (in this example) similar down-range and cross-range resolutions. Second window 550 is depicted similar to that in FIG. 5 and depicted with grey shading. However, the addition of receiver 610 and its overlapping detection capabilities effectively eliminates some possible spatial locations of the target, resulting in third window 650, which is significantly smaller than second window 550. In this way, the accuracy of target location is enhanced both in range and in angular measure. While the examples of FIGS. 5 and 6 are simplified and depicted as planar two-dimensional diagrams, the same teachings apply for application in three dimensions (e.g., spheres of detection) and also if the transmitter and/or receivers are directional (e.g., as in FIGS. 3 and 4).

Embodiments of the present disclosure can utilize the coherent distributed collection of nodes to track targets. For example, one such system can include a first receiver that has a first location and a second receiver that has a second location. The determined range can have a range accuracy based at least on the time synchronization between the first receiver and the second receiver. The system can also determine an angular accuracy based on a spatial diversity of the first receiver and the second receiver, and antenna beamforms of the first receiver and the second receiver. The term “spatial diversity” refers to known locations of the nodes that are distributed over an area. As described previously, having spatially diverse nodes can improve the accuracy of target locating, as compared to a set of nodes that might be more clustered. As such, computer processors utilized for range/location determination can be configured to determine a range accuracy based on the range, range accuracy, and angular accuracy. As shown in FIG. 6, the angular accuracy can be determined based on a volume formed by a union of overlapping detection volumes of the first receiver and the second receiver.

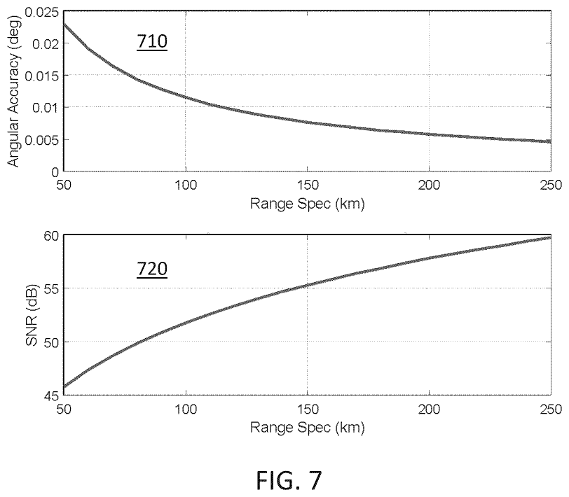

FIG. 7 depicts plots illustrating how an increase in signal-to-noise can maintain accuracy even as range increases. Various embodiments of the present disclosure can leverage lower frequencies that result in several advantages over higher frequency applications. For example, the range accuracy of the system can be expressed by:

$$Range Accuracy = \frac{Range resolution}{\sqrt{2 * SNR}} . \qquad ( Eq . 3 )$$

In Eq. 3, SNR is Signal-to-Noise Ratio. The above equation describes the single monolithic node range accuracy performance. Range resolution can be dictated by frequency bandwidth as discussed and as the signal-to-noise ratio increases the range accuracy continues to improve, with a lower range accuracy number being better. This is because the exact timing of when the peak of a signal can be detected becomes very precise at very high signal-to-noise ratios. Multiple receiver nodes can achieve a better range accuracy number than this using the multilateration techniques described previously.
Similarly, the angular accuracy of the system can be expressed by:

$$Angular Accuracy = \frac{Angular resolution}{\sqrt{2 * SNR}} . \qquad ( Eq . 4 )$$

As previously explained, the angular resolution decreases with target distance from a receiver. This dependence is shown by plot 710, showing one example of a fall-off of angular accuracy with range from the receiver. Some embodiments can utilize improved SNR to compensate for this fall-off. Plot 720 shows an example of how SNR would have to increase to maintain a particular angular accuracy at different ranges. The plots of FIG. 7 are shown for example purposes only and the actual values may vary with the particulars of the implemented system. Because RF attenuates with the square of its frequency, utilizing low-frequency systems can improve SNR. Accordingly, in some embodiments, the first receiver and the second receiver can be configured to receive signals (e.g., first signal 112 and second signal 122) having a frequency of less than 6 MHz. In other embodiments, the frequency can be less than 200 MHz. In yet other embodiments, the frequency can be between 2 and 20 MHz. As one example embodiment, the system can be configured to determine the range to within 10 m utilizing at least two receivers configured to receive a signal of less than 20 MHz. Compared with GHz range RF, such embodiments can provide improved target tracking, or comparable target tracking, but without the increased technical requirements that come with GHz systems.

As described herein, it can be beneficial to utilize numerous nodes. While the benefits of multiple receivers have been discussed, some embodiments also utilize multiple transmitters. In some embodiments, there can be multiple transmitters configured to generate signals that have a distinguishing characteristic that allows them to be distinguished at a receiver. Such signals can be received by a processor configured to determine the range (or location, etc.) further based on the distinguishing characteristic. In various embodiments, the distinguishing characteristic can be a difference in one or more of a phase, a frequency, an amplitude, a polarization, time of transmission, or spatial location of transmission. Such differences can allow discrimination of signals so as to provide information about their originating node. For example, if a node at a particular location is known to emit at a particular frequency, the signals received at the one or more transmitters can be known to have originated from that node/location.

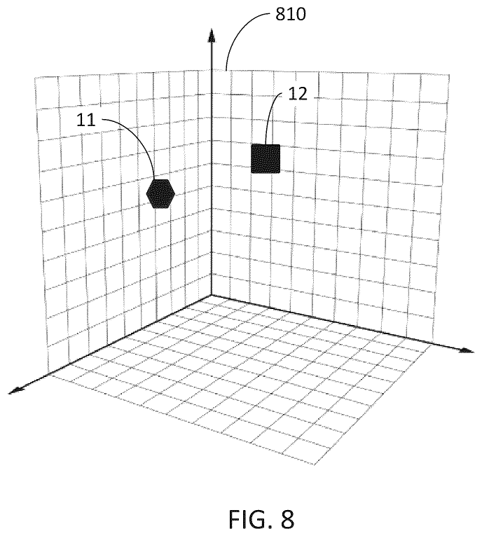

FIG. 8 depicts an example of a five-dimensional representation of received signals during target tracking. In some embodiments, the system can be configured to determine a location of the target from the first signal and the second signal and determining doppler frequencies of the first signal and the second signal. The location (e.g., in three dimensions) and doppler frequencies (and thus velocities of the target) can, in some embodiments, evolve and thus be tracked over time. For example, the above-described target tracking can be performed but with time-varying doppler frequencies and velocities, referred to as non-constant velocity target tracking or accelerating or decelerating target tracking. A five-dimensional map 810 is one example representation of such data that can be generated by a computer system analyzing the received signals. Five-dimensional map 810 can include a three-dimensional location of the target, as a function of time, and as a function of the doppler frequencies. As shown in FIG. 8, at a first time, the target with represented by first multi-dimensional data 11 can be depicted as being tracked based on signals of a certain frequency (represented in FIG. 8 by the hexagonal shape of first multi-dimensional data 11). At a second time, the target can be represented by second multi-dimensional data 12, represented by the now square shape, with the shape based on a change in frequency. In various embodiments, the five-dimensional data can be stored as five-dimensional arrays, vectors, etc. suitable for signals analysis. Target tracking, where the state of an object including the three-dimensional position as well as velocity of the target over time is highly desired in applications to predict where the target is going. In commercial aviation this can be used to mitigate collisions, in military aviation this capability can be used to track enemy aircraft and fire a missile at enemy aircraft. A Kalman filter tracking algorithm and many other tracking algorithms can be utilized for such applications. In some embodiments, the three-dimensional position and velocity being tracked over time can be done at the system level, meaning a multistatic system with many receiver nodes can have various receivers report the determined three-dimensional position and doppler frequency (velocity) back to a central or distributed processing algorithm. Because the reported position/frequency/velocity may not be exactly the same, the system can then determine the overall 3D position and velocity of the target, since the system can possibly achieve a better accuracy of the position and velocity than a single node can on its own. The tracking algorithm can then be performed at the system level after the system position and velocities are calculated. Other embodiments can have individual node(s) implement a tracking algorithm, with the determined tracks correlated at the system level.

It is contemplated that any of the embodiments described herein can be applied in a wide variety of situations and for use with numerous types of targets. For example, in various embodiments, the target can be moving, e.g. an aircraft or maritime vessel. In other embodiments, the target can be stationary, such as for locating a geological feature. In various embodiments, receivers can be located on ground stations, stations on boats, and stations on crewed and uncrewed aircraft. Subsurface geolocating objects underground can include locating critical minerals, metals, and other materials for mining applications, drill bits, geothermal tunnels, land mines, or any other subsurface materials. In some cases, the target itself can be the source of signals captured at the receiver(s) and so the disclosed embodiments can be utilized to determine signal originations. This can include mapping out in 3-dimensional space where the signals are coming from. Other uses include radar applications from a group of aircraft (e.g., containing the transmitters and/or receivers), either air-to-ground or air-to-air.

In some embodiments, the system can act as passive radar where the receivers can lock onto signals of opportunity. For example, an aircraft might not be emitting or reflecting signals at certain times, but were an appropriate signal emitted/reflected from an aircraft, the passive receivers can detect such signals and locate the target. While for ease of explanation the present disclosure describes the tracking of a single target, the disclosed embodiments can be extended to tracking multiple targets (e.g., 100's or 1000's of targets such as a group of aircraft or a drone swarm). Such multi-target tracking can be facilitated by signal discrimination as described in several ways herein. Also, while a beneficial technical advantage can be realized by using less complex nodes rather than conventional high-frequency radar systems, the present disclosure contemplates that the multilateration techniques described herein can also be implemented with such radar systems acting as transmitters and/or receivers.

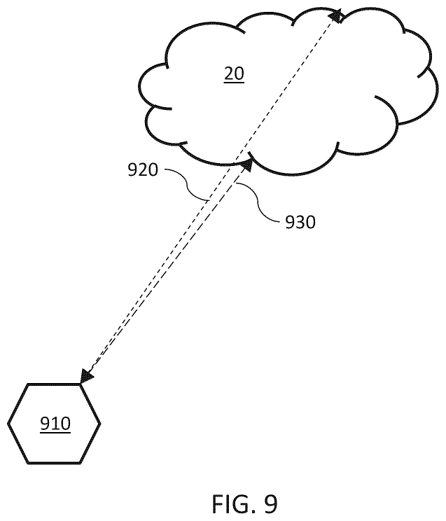

FIG. 9 depicts an embodiment that can be utilized for determining the size of a gaseous target. In addition to the emission/reflection from the surface of a target as previously described, some systems can be configured to analyze signals returned from a target where the signals include those that are attenuated and thereby contain information about the size of the target. An application of such can be determining the thickness and location of a gas cloud after some signal is attenuated and/or reflected from the cloud. As shown in FIG. 9, a transceiver 910 (which can also be separate components, such as a node for transmission and another node for receiving) can be configured to emit at least two different signals. First signal 920 can be tuned to an absorption line of target 20 and second signal 930 is not tuned to an absorption line of target 20. First signal 920 can enter target 20 and be simultaneously reflected back to transceiver 910 and attenuated by target 20. Second signal 930 can be effectively reflected by target 20 and thus can be utilized similarly to preceding embodiments to determine its range/location. A processor can be configured to determine the size of the target based on attenuation of first signal 920 after passing through target 20.

In some embodiments, differential absorption can be implemented as a signal, such as a LiDAR or radar signal, can be is pulsed, reflected off a reflector (such the ground or another object), and passed through the cloud twice. The amount of energy that is absorbed by the cloud can be computed at the receiver after the signal is received. Then, a density of the cloud can be computed as well as how much of the molecule is present in the line-of-site of signal. Since molecules absorption rates are highly dependent on specific frequencies, a frequency can be paired with a specific type of molecule such that only a certain type of molecule will be highly absorptive. With this method, optionally even with a single node, it can be determined whether a cloud is present, what type of molecule the cloud is made of, how dense the cloud is, etc. In some embodiments, where multiple different angles of signals are used and pass through the clouds at different angles, the angles and lines where the different receivers detected the cloud can be computed and stored and time synchronized. With multiple transmitter/receivers, the angles where the signals from the different nodes crossed and detected and the presence of a molecule can then be utilized to determine the size of the cloud. Such a determination can be performed in a variety of ways, with one simplified example based on the extinction law along with the reflectance of the signal as it passes through target 20:

$$I ( d ) = \frac{R ( 1 - R ) {I}_{0} {e}^{- μ d}}{1 - {Re}^{- μ d}} , \qquad ( Eq . 5 )$$

where I(d) is the intensity of the initial signal (I₀) received back at the source, R is the reflectivity of target 20, μ is the attenuation coefficient (e.g., as based on the particular absorption line selected), and d is the distance over which the absorption occurs (e.g., the thickness of the gas cloud). For a known gas (or liquid) μ and R can be known quantities, and based on the received light transmitted (i.e., reflected back to the receiver) as it traverses target 20 the system can perform calculations to determine the thickness d of target 20. This embodiment can be implemented as an application of the aforementioned systems (e.g., the system in FIG. 1), or can be a different system. In various embodiments, first signal and the second signal can be RF signals, laser beams, etc.

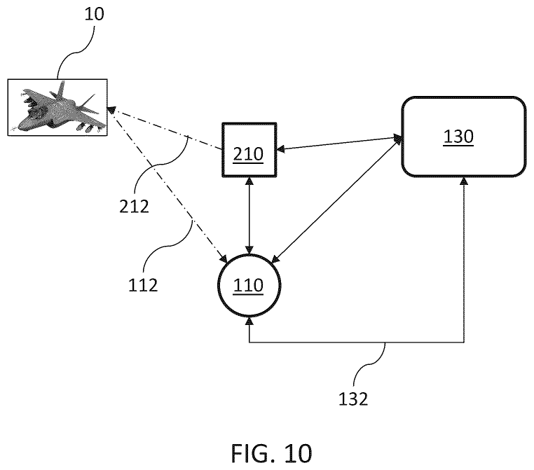

FIG. 10 is a diagram illustrating a simplified system utilizing one receiver and one transmitter. While many embodiments leverage multiple transmitters and/or receivers to provide various technical advantages, in some embodiments the required target tracking accuracy can be obtained with a single transmitter and receiver. This embodiment is similar to that shown in FIG. 2 and uses corresponding reference numbers. In the example of FIG. 10, a system can include transmitter 210 configured for transmitting an outgoing signal 212 to target 10. Receiver 110 can be configured for receiving an incoming signal 112 from target 10, with receiver 110 time-synchronized with transmitter 210. Programmable processor 130 can be configured to determine a range to target 10 based on an arrival time of the incoming signal 112 at receiver 110.

In the following, further features, characteristics, and exemplary technical solutions of the present disclosure will be described in terms of items that may be optionally claimed in any combination:

Item 1: A system for locating a target, the system comprising: a first receiver configured for receiving a first signal from the target; a second receiver configured for receiving a second signal from the target, the second receiver time-synchronized with the first receiver; and a programmable processor configured to determine a range to the target based on arrival times of the first signal at the first receiver and the second signal at the second receiver.

Item 2: The system of Item 1, wherein the first receiver and the second receiver are time synchronized directly with each other.

Item 3: The system of any one of the preceding Items, wherein the first receiver and the second receiver are time synchronized with an external clock.

Item 4: The system of any one of the preceding Items, wherein the first receiver and the second receiver are time synchronized to within 10 nanoseconds.

Item 5: The system of any one of the preceding Items, wherein the first receiver and the second receiver are time synchronized to within 10 picoseconds.

Item 6: The system of any one of the preceding Items, further comprising a transmitter configured to emit a third signal that causes generation of the first signal and the second signal.

Item 7: The system of any one of the preceding Items, wherein the transmitter is configured to generate the third signal omni-directionally.

Item 8: The system of any one of the preceding Items, wherein the transmitter is configured to generate the third signal to have a transmitter beamform.

Item 9: The system of any one of the preceding Items, the processor further configured to limit the range of the target to be based on a location within the transmitter beamform.

Item 10: The system of any one of the preceding Items, further comprising a second transmitter configured to emit a fourth signal that causes generation of the first signal and the second signal in response to transmission of the fourth signal, the processor further configured to toggle between the first transmitter and the second transmitter to generate the first signal and the second signal.

Item 11: The system of any one of the preceding Items, further comprising a second transmitter configured to emit a fourth signal that causes generation of the first signal and the second signal in response to transmission of the fourth signal, wherein the first transmitter and the second transmitter are offset in frequency to provide a first frequency bandwidth and a second frequency bandwidth that provides a total frequency bandwidth larger than the first frequency bandwidth and the second frequency bandwidth, and wherein the first receiver or the second receiver is configured to receive the total frequency bandwidth.

Item 12: The system of any one of the preceding Items, wherein the third signal and the fourth signal are generated phase coherently or pulse coherently.

Item 13: The system of any one of the preceding Items, wherein the first receiver or the second receiver have a linear array of antenna elements.

Item 14: The system of any one of the preceding Items, wherein the first receiver has a first linear array in a vertical direction and the second receiver has a second linear array in a vertical direction.

Item 15: The system of any one of the preceding Items, wherein the first receiver or the second receiver are further configured to transmit outgoing signals to another system.

Item 16: The system of any one of the preceding Items, wherein the first receiver has a first location and the second receiver has a second location, and the range has a range accuracy based on the time synchronization between the first receiver and the second receiver, and an angular accuracy based on a spatial diversity of the first receiver and the second receiver, and antenna beamforms of the first receiver and the second receiver, the processor further configured to: determine a range accuracy based on the range, range accuracy, and angular accuracy, where the angular accuracy is determined based on a volume formed by a union of overlapping detection volumes of the first receiver and the second receiver.

Item 17: The system of any one of the preceding Items, the processor further configured to: determine a time-synchronization level of the system that provides the range accuracy by a multilateration method; determine the time-synchronization level of the system for an interferometric range accuracy by an interferometric method utilizing the first signal and the second signal; and switch to the multilateration method or the interferometric method based on the time-synchronization level.

Item 18: The system of any one of the preceding Items, wherein the first receiver and the second receiver are configured to receive the first signal and the second signal having a frequency of less than 6 MHz.

Item 19: The system of any one of the preceding Items, wherein the first receiver and the second receiver are configured to receive the first signal and the second signal having a frequency of less than 200 MHz.

Item 20: The system of any one of the preceding Items, the first receiver and the second receiver are configured to receive the first signal and the second signal having a frequency of between 2 and 20 MHz.

Item 21: The system of any one of the preceding Items, wherein the system is configured to determine the range to within 10 m utilizing at least two receivers configured to receive a signal of less than 20 MHz.

Item 22: The system of any one of the preceding Items, further comprising a plurality of transmitters to generate signals that have a distinguishing characteristic that allows them to be distinguished at a receiver, the processor further configured to determine the range further based on the distinguishing characteristic.

Item 23: The system of any one of the preceding Items, wherein the distinguishing characteristic is a difference in one or more of a phase, a frequency, an amplitude, a polarization, time of transmission, or spatial location of transmission.

Item 24: The system of any one of the preceding Items, further comprising determining a location of the target from the first signal and the second signal and determining doppler frequencies of the first signal and the second signal.

Item 25: The system of any one of the preceding Items, further comprising generating a five-dimensional map comprising a three-dimensional location of the target, as a function of time, and as a function of the doppler frequencies.

Item 26: The system of any one of the preceding Items, wherein the target is moving.

Item 27: The system of any one of the preceding Items, wherein the target is an aircraft.

Item 28: The system of any one of the preceding Items, wherein the target is a maritime vessel.

Item 29: The system of any one of the preceding Items, wherein the target is stationary.

Item 30: The system of any one of the preceding Items, wherein the target is a geological feature.

Item 31: The system of any one of the preceding Items, wherein the first signal is tuned to an absorption line of the target and the second signal is not tuned to an absorption line of the target, the processor further configured to determine a size of the target based on an attenuation of the first signal after passing through the target.

Item 32: The system of any one of the preceding Items, wherein the first signal and the second signal are RF signals.

Item 33: The system of any one of the preceding Items, wherein the first signal and the second signal are laser beams.

Item 34: A system for locating a target, the system comprising: a transmitter configured for transmitting an outgoing signal to the target; a receiver configured for receiving an incoming signal from the target, the receiver time-synchronized with the transmitter; and a programmable processor configured to determine a range to the target based on an arrival time of the incoming signal at the receiver.

A method utilizing the system and operations as in any of Items 1-34.

A non-transitory, machine-readable medium storing instructions which, when executed by at least one programmable processor, cause the at least one programmable processor to perform operations as in any one of Items 1-34.

The present disclosure contemplates that the calculations disclosed in the embodiments herein may be performed in a number of ways, applying the same concepts taught herein, and that such calculations are equivalent to the embodiments disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above-described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A system for locating a target, the system comprising:
a first receiver configured for receiving a first signal from the target;
a second receiver configured for receiving a second signal from the target, the second receiver time-synchronized with the first receiver; and
a programmable processor configured to determine a range to the target based on arrival times of the first signal at the first receiver and the second signal at the second receiver.

2. The system of claim 1, wherein the first receiver and the second receiver are time synchronized directly with each other.

3. The system of claim 1, wherein the first receiver and the second receiver are time synchronized with an external clock.

4. The system of claim 1, wherein the first receiver and the second receiver are time synchronized to within 10 nanoseconds.

5. The system of claim 4, wherein the first receiver and the second receiver are time synchronized to within 10 picoseconds.

6. The system of claim 1, further comprising a transmitter configured to emit a third signal that causes generation of the first signal and the second signal.

7. The system of claim 6, wherein the transmitter is configured to generate the third signal omni-directionally.

8. The system of claim 6, wherein the transmitter is configured to generate the third signal to have a transmitter beamform.

9. The system of claim 8, the processor further configured to limit the range of the target to be based on a location within the transmitter beamform.

10. The system of claim 6, further comprising a second transmitter configured to emit a fourth signal that causes generation of the first signal and the second signal in response to transmission of the fourth signal, the processor further configured to toggle between the transmitter and the second transmitter to generate the first signal and the second signal.

11. The system of claim 6, further comprising a second transmitter configured to emit a fourth signal that causes generation of the first signal and the second signal in response to transmission of the fourth signal, wherein the transmitter and the second transmitter are offset in frequency to provide a first frequency bandwidth and a second frequency bandwidth that provides a total frequency bandwidth larger than the first frequency bandwidth and the second frequency bandwidth, and wherein the first receiver or the second receiver is configured to receive the total frequency bandwidth.

12. The system of claim 11, wherein the third signal and the fourth signal are generated phase coherently or pulse coherently.

13. The system of claim 1, wherein the first receiver or the second receiver have a linear array of antenna elements.

14. The system of claim 13, wherein the first receiver has a first linear array in a vertical direction and the second receiver has a second linear array in a vertical direction.

15. The system of claim 1, wherein the first receiver or the second receiver are further configured to transmit outgoing signals to another system.

16. The system of claim 1, wherein the first receiver has a first location and the second receiver has a second location, and the range has a range accuracy based on the time synchronization between the first receiver and the second receiver, and an angular accuracy based on a spatial diversity of the first receiver and the second receiver, and antenna beamforms of the first receiver and the second receiver, the processor further configured to:
determine a range accuracy based on the range, range accuracy, and angular accuracy, where the angular accuracy is determined based on a volume formed by a union of overlapping detection volumes of the first receiver and the second receiver.

17. The system of claim 16, the processor further configured to:
determine a time-synchronization level of the system that provides the range accuracy by a multilateration method;
determine the time-synchronization level of the system for an interferometric range accuracy by an interferometric method utilizing the first signal and the second signal; and
switch to the multilateration method or the interferometric method based on the time-synchronization level.

18. The system of claim 1, wherein the first receiver and the second receiver are configured to receive the first signal and the second signal having a frequency of less than 6 MHz.

19. The system of claim 18, wherein the first receiver and the second receiver are configured to receive the first signal and the second signal having a frequency of less than 200 MHz.

20. The system of claim 19, the first receiver and the second receiver are configured to receive the first signal and the second signal having a frequency of between 2 and 20 MHz.

21. The system of claim 1, wherein the system is configured to determine the range to within 10 m utilizing at least two receivers configured to receive a signal of less than 20 MHz.

22. The system of claim 1, further comprising a plurality of transmitters to generate signals that have a distinguishing characteristic that allows them to be distinguished at a receiver, the processor further configured to determine the range further based on the distinguishing characteristic.

23. The system of claim 22, wherein the distinguishing characteristic is a difference in one or more of a phase, a frequency, an amplitude, a polarization, time of transmission, or spatial location of transmission.

24. The system of claim 1, further comprising determining a location of the target from the first signal and the second signal and determining doppler frequencies of the first signal and the second signal.

25. The system of claim 24, further comprising generating a five-dimensional map comprising a three-dimensional location of the target, as a function of time, and as a function of the doppler frequencies.

26. The system of claim 1, wherein the target is moving.

27. The system of claim 26, wherein the target is an aircraft.

28. The system of claim 1, wherein the target is a maritime vessel.

29. The system of claim 1, wherein the target is stationary.

30. The system of claim 29, wherein the target is a geological feature.

31. The system of claim 1, wherein the first signal is tuned to an absorption line of the target and the second signal is not tuned to an absorption line of the target, the processor further configured to determine a size of the target based on an attenuation of the first signal after passing through the target.

32. The system of claim 31, wherein the first signal and the second signal are RF signals.

33. The system of claim 31, wherein the first signal and the second signal are laser beams.

34. A system for locating a target, the system comprising:
a transmitter configured for transmitting an outgoing signal to the target;
a receiver configured for receiving an incoming signal from the target, the receiver time-synchronized with the transmitter; and
a programmable processor configured to determine a range to the target based on an arrival time of the incoming signal at the receiver.

35. A non-transitory, machine-readable medium storing instructions which, when executed by at least one programmable processor, cause the at least one programmable processor to perform operations comprising:
obtaining at a first receiver, a first signal from a target;
obtaining, at a second receiver that is time-synchronized with the first receiver, a second signal from the target; and
determining a range to the target based on arrival times of the first signal at the first receiver and the second signal at the second receiver.

36. The machine-readable medium of claim 35, further comprising controlling a transmitter to emit a third signal that causes generation of the first signal and the second signal.

37. The machine-readable medium of claim 36, further comprising:
generating the third signal to have a transmitter beamform; and
limiting the range of the target to be based on a location within the transmitter beamform.

38. The machine-readable medium of claim 35, wherein the first receiver has a first location and the second receiver has a second location, and the range has a range accuracy based on the time synchronization between the first receiver and the second receiver, and an angular accuracy based on a spatial diversity of the first receiver and the second receiver, and antenna beamforms of the first receiver and the second receiver, the operations further comprising:
determining a range accuracy based on the range, range accuracy, and angular accuracy, where the angular accuracy is determined based on a volume formed by a union of overlapping detection volumes of the first receiver and the second receiver.

39. The machine-readable medium of claim 35, further comprising determining the range further based on a distinguishing characteristic of the first signal and second signal as generated by transmitters configured to generate signals with the distinguishing characteristic.

40. The machine-readable medium of claim 35, further comprising:
tuning the first signal to an absorption line of the target;
tuning the second signal to not be at an absorption line of the target; and
determining a size of the target based on an attenuation of the first signal after passing through the target.

41. A method for implementation by at least one programmable processor, the method comprising:
obtaining at a first receiver, a first signal from a target;
obtaining, at a second receiver that is time-synchronized with the first receiver, a second signal from the target; and
determining a range to the target based on arrival times of the first signal at the first receiver and the second signal at the second receiver.

42. The method of claim 41, further comprising controlling a transmitter to emit a third signal that causes generation of the first signal and the second signal.

43. The method of claim 42, further comprising:
generating the third signal to have a transmitter beamform; and
limiting the range of the target to be based on a location within the transmitter beamform.

44. The method of claim 41, wherein the first receiver has a first location and the second receiver has a second location, and the range has a range accuracy based on the time synchronization between the first receiver and the second receiver, and an angular accuracy based on a spatial diversity of the first receiver and the second receiver, and antenna beamforms of the first receiver and the second receiver, the method further comprising:
determining a range accuracy based on the range, range accuracy, and angular accuracy, where the angular accuracy is determined based on a volume formed by a union of overlapping detection volumes of the first receiver and the second receiver.

45. The method of claim 41, further comprising determining the range further based on a distinguishing characteristic of the first signal and second signal as generated by transmitters configured to generate signals with the distinguishing characteristic.

46. The method of claim 41, further comprising:
tuning the first signal to an absorption line of the target;
tuning the second signal to not be at an absorption line of the target; and
determining a size of the target based on an attenuation of the first signal after passing through the target.
